(19) United States
(12) Patent Application Publication
(10) Pub. No.: US 2010/0008514 A1
(43) Pub. Date: Jan. 14, 2010

(54) APPARATUS AND SYSTEM FOR AN AUDIO BELT BUCKLE

(76) Inventors: Ian Bates, Logan, UT (US); David Williams, Logan, UT (US); Chase Wallis, Logan, UT (US)

Correspondence Address: Kunzler & McKenzie, 8 EAST BROADWAY, SUITE 600, SALT LAKE CITY, UT, 84111, US

(21) Appl. No.: 12/503,011

(22) Filed: Jul. 14, 2009

Related U.S. Application Data
(60) Provisional application No. 61/080,464, filed on Jul. 14, 2008.

(51) Int. Cl. A44B 11/25; H04R 1/02; H04R 3/00; G10L 21/00; H04B 1/06; G06F 17/30

(52) U.S. Cl. 381/77; 24/163 K; 381/394; 381/122; 704/500; 707/104.1

(57) ABSTRACT

An apparatus, system, and method are disclosed for an audio belt buckle. The audio belt buckle contains a belt buckle housing, at least one speaker, an audio input receiver, an amplification device, and a power source. The belt buckle housing is coupled to a first end of a belt of a user. The belt buckle housing is configured to secure an opposing end of the belt to hold the belt around the waist of a user. The speaker is coupled to the belt buckle housing and is directed away from the user's body. The audio input receiver is also coupled to the belt buckle housing and is configured to receive audio input. The amplification device is coupled to the audio input, the speaker, and the power source.

### CROSS-REFERENCES TO RELATED APPLICATIONS

This application claims priority to U.S. Provisional Patent Application No. 61/080,464 entitled “Apparatus and system for a wearable speaker” and filed on Jul. 14, 2008 for Ian A. Bates, which is incorporated herein by reference.

### BACKGROUND OF THE INVENTION

Portable audio devices have become increasingly popular over the past several years. With the increase in the number of users of portable audio devices, several deficiencies have been exposed in currently available technology. Specifically, users need an alternative to current speaker and headphone technology. The use of headphones presents several problems for users including fatigue after extended use, social isolation, and the inability to hear important environmental sounds such as emergency sirens. Portable speaker use often necessitates transportation of several separate devices which are cumbersome to use and transport.

A need exists for a portable apparatus and system that allow users to listen to music and other sound recordings without the use of headphones. Beneficially, such an apparatus and system would deliver the desired audio recordings without shutting off the user's auditory connection with people and objects in the world around him. This apparatus, system and method would provide social and safety benefits to the user and those around him by allowing users to be cognizant of his surroundings while listening to music. This apparatus and system would also provide an audio source for the simultaneous benefit of multiple users.

The present invention has been developed in response to the present state of the art, and in particular, in response to the problems and needs in the art that have not yet been fully solved by currently available headphones or portable speaker systems. Accordingly, the present invention has been developed to provide an apparatus and system for playing audio recordings in a lightweight, portable system that does not require headphone use.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### SUMMARY

From the foregoing discussion, it should be apparent that a need exists for an apparatus and system that allow users to listen to music and other sound recordings without the use of headphones. The present invention has been developed in response to the present state of the art, and in particular, in response to the problems and needs in the art that have not yet been fully solved by currently available audio devices. Accordingly, the present invention has been developed to provide an apparatus and system for playing audio recordings that overcome many or all of the above-discussed shortcomings in the art.

The apparatus, in one embodiment, contains a belt buckle housing, at least one speaker, an audio input receiver, an amplification device, and a power source. The belt buckle housing is coupled to a first end of a belt of a user and is configured to secure an opposing end of the belt to hold the belt around the waist of a user. The speaker may be coupled to the belt buckle housing and is directed away from the user's body. The audio input receiver is coupled to the belt buckle housing and is configured to receive audio input from an audio source. The audio input is also coupled to the speaker. The amplification device is also coupled to the audio input receiver and the speaker. Lastly, the power source is coupled with the amplification device.

In one embodiment, the belt buckle housing contains a substantially planar front surface which contains a display area for communicating a message. In another embodiment, the belt buckle housing is shaped as a popular culture figure. In one embodiment, the popular culture figure is a cartoon character.

In one embodiment, the audio input receiver contains a wireless input receiver. In another embodiment, the audio input receiver contains an audio socket which is configured to receive an audio plug. The audio socket is electrically coupled to the speaker and contains a length of wire coupled to an output audio jack at a proximal end. The distal end is coupled with an input audio jack. In this embodiment, the output audio jack is configured to interface with the audio socket and the input audio jack is configured to interface with the audio source.

In one embodiment, the apparatus contains a microphone and a microphone power source. The microphone contains an acoustic to electric sensor that converts a sound into an electrical signal. The microphone is coupled to the audio input receiver such that the audio input receiver receives the electrical signal as the audio input.

In another embodiment, the belt buckle housing contains a front cover, a back cover, and a center cavity. In this embodiment, a speaker is disposed on the front cover of the belt buckle housing and is directed away from the center cavity. In another embodiment, the belt buckle housing also contains a loop and a pin disposed on an outer surface of the belt buckle housing. The loop is configured to couple to the first end of the belt and the pin is configured to fit within a hole on the opposing end of the belt.

In another embodiment, the audio belt buckle contains an audio source, a music decoder, and a user interface which are all disposed within the belt buckle housing. The music decoder is coupled to the audio source and is configured to decode an audio signal from the audio source. The user interface contains an audio input control and an audio output control. The audio input control is configured to control audio input while the audio output control is configured to control audio output.

In another embodiment, the audio source contains an audio storage device which is configured to store electronic files.

In a further embodiment, the belt buckle housing contains an audio source receiving port. The audio source receiving port is configured to removably receive the audio source.

In another embodiment, the audio belt buckle contains a bracket which is configured to attach to a user's belt and to secure the first end of the user's belt to the opposing end of the belt. The belt buckle housing contains a speaker assembly which can be removably attached to the bracket.

A system is also described for securing an audio belt buckle to a user. The system contains a belt worn on a user's waist, a belt buckle housing which contains a speaker assembly, a bracket, at least one speaker, an audio input receiver, an amplification device, and a power source. The belt buckle housing is designed to contain a front cover, a back cover and a center cavity. The bracket is coupled to a first end of the user's belt and is configured to secure to an opposing end of the belt to hold the belt around the waist of the user. The speaker assembly can then be removably attached to the bracket.

In this system, at least one speaker is coupled to the front cover of the belt buckle housing. The speaker is directed away from the user's body. The audio input receiver is also coupled to the belt buckle housing and is configured to receive audio input from an audio source. The audio input receiver is also coupled to the speakers. Lastly, the amplification device is coupled to the audio input receiver, the speakers and the power source.

In another embodiment of the system, the belt buckle housing is shaped as a popular culture figure. In yet another embodiment of the system, the audio input receiver contains a wireless input receiver.

In another embodiment, the system contains an audio source, music decoder and user interface which are disposed within the belt buckle housing. The music decoder is coupled to the audio source and is configured to decode an audio signal from the audio source. The user interface is disposed within the belt buckle housing and contains an audio input control and audio output control. The audio input control and audio output control are similar to those discussed above.

In another embodiment of the system, the belt buckle housing contains an audio source receiving port which is configured to removably receive the audio source.

An audio belt buckle is also described which contains a belt buckle housing, at least one speaker, an audio input receiver, an amplification device, and a power source. In this embodiment, the belt buckle housing contains a front cover, a back cover, a center cavity, and an audio source receiving port. The audio source receiving port is configured to removably receive an audio source. As described above, the belt buckle housing is coupled to a first end of a belt and configured to secure an opposing end of the belt to hold the belt around a user's waist.

As described in previous embodiments, the speaker is directed away from the user's body and is coupled with the belt buckle housing. The audio input receiver is also coupled with the belt buckle housing and is configured to receive audio input from the audio source. The audio input receiver is also coupled to the speakers. Lastly, the amplification device is coupled to the audio input receiver, the speaker and the power source.

In one embodiment, the audio belt buckle also contains a bracket and speaker assembly, substantially as described above.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only some embodiments of the invention and are not therefore to be considered to be limiting of its scope, the invention will be described and explained with additional specificity and detail through the use of the accompanying drawings, in which:

FIG. 1A is a perspective view illustrating one embodiment of an audio belt buckle in accordance with the present invention;

FIG. 1B is a rear view illustrating one embodiment of the audio belt buckle of FIG. 1A;

FIG. 1C is a side view illustrating one embodiment of the audio belt buckle of FIG. 1A;

FIG. 2A is a cut-away perspective view of a front cover of one embodiment of an audio belt buckle;

FIG. 2B is a cut-away perspective view of another embodiment of a front cover of an audio belt buckle;

FIG. 3A is a back view of a back cover of one embodiment of an audio belt buckle;

FIG. 3B is a front view of the embodiment of FIG. 3A;

FIG. 4 is a view illustrating one embodiment of an audio belt buckle;

FIG. 5A is a top view of one embodiment of an audio belt buckle used with a friction-type belt;

FIG. 5B is a front view of one embodiment of an audio belt buckle used with a loop-and-bar belt;

FIG. 6 is a side view of one embodiment of an audio belt buckle; and

FIG. 7 is a perspective view of another embodiment of an audio belt buckle.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of mechanical design, electrical connections, hardware circuits, manufacturing techniques, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

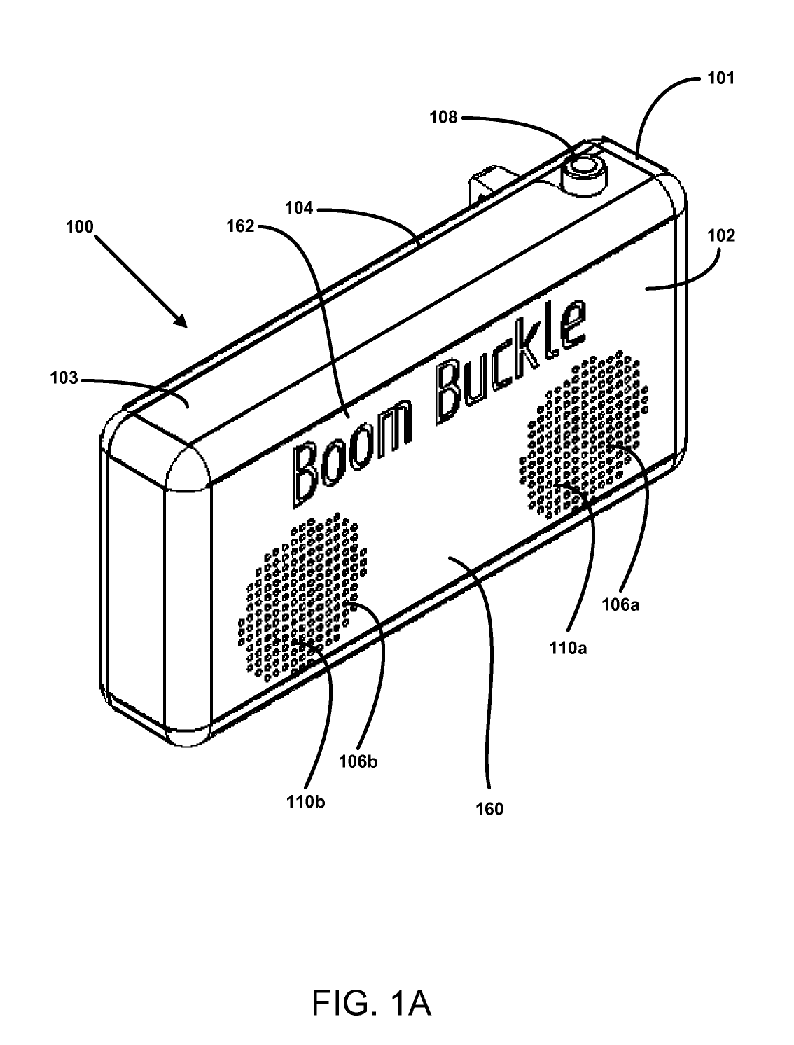

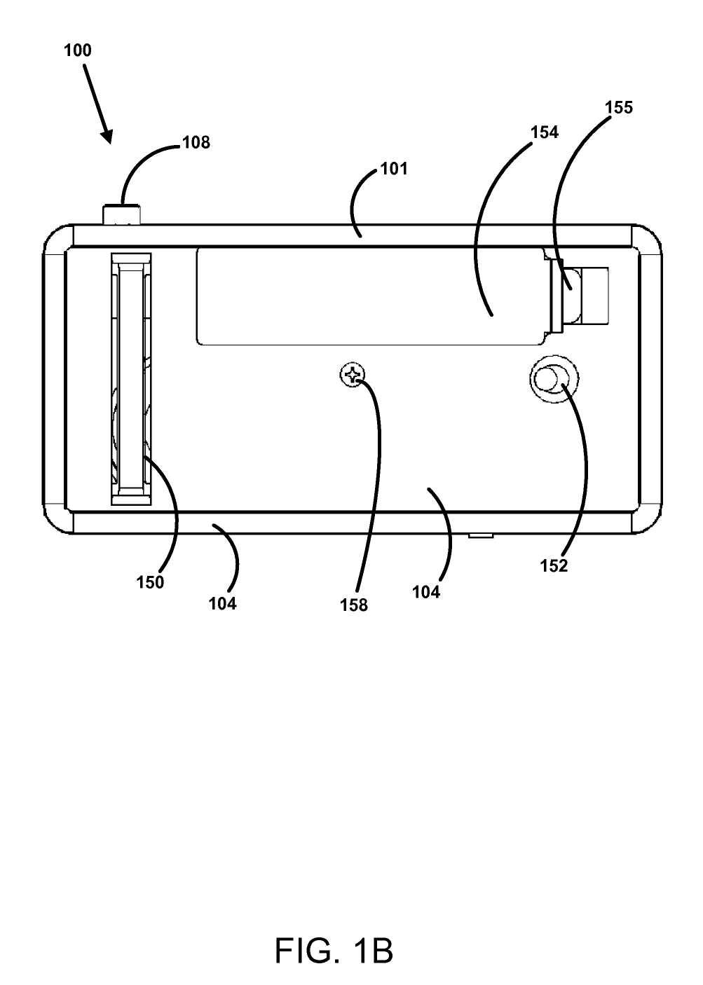

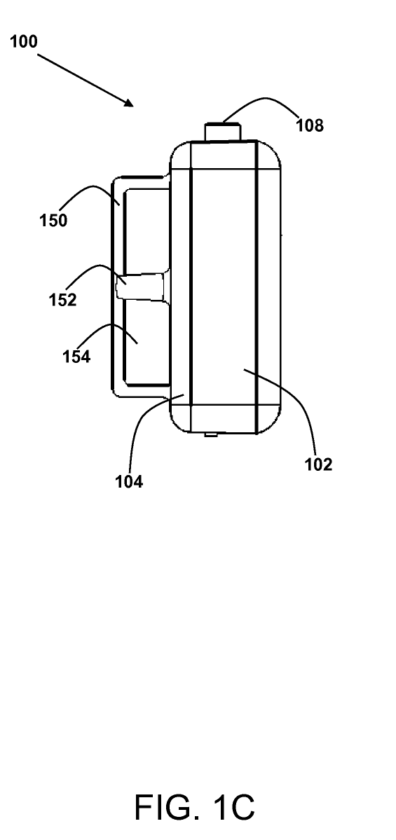

FIG. 1A depicts one embodiment of an audio belt buckle 100 comprising a belt buckle housing 101, at least one speaker 106a, 106b, an audio input receiver 108, an amplification device (not shown), and a power source (not shown). In one embodiment, the belt buckle housing 101 is configured to attach to and secure a belt of a user. In another embodiment, at least one speaker is contained within the belt buckle housing 101 and is directed away from the user's body. In certain embodiments, the audio belt buckle 100 includes two speakers contained within the belt buckle housing 101. In one embodiment, the belt buckle housing 101 of the audio belt buckle 100 is formed by a front cover 102 and a back cover 104. The covers 102, 104 may be formed of injection-molded plastic, aluminum, stainless steel, or another material. One of skill in the art will recognize that the belt buckle housing 101 can be made of plurality of sections, from one complete part, from a plurality of manufacturing methods, from a plurality of materials and in a plurality of shapes and sizes. The embodiments shown in this application and the associated figures are illustrative of only some of the possible embodiments. For example, in the embodiment of FIG. 1A, the belt buckle housing 101 is rectangular in shape with rounded edges. In another embodiment, a smaller, oval shaped belt buckle housing 101 is used. This shape may be advantageous for users who intend to use the audio belt buckle while running.

In certain embodiments the front cover 102 includes a substantially planar front surface 160. The substantially planar front surface 160 on the front cover 102 includes a display area 162 for communicating a message. For example, in the embodiment illustrated in FIG. 1A the display area 162 displays the term “Boom Buckle.” In other embodiments, a larger front cover 102 may be desired for placement of a logo or other writing. In certain embodiments the belt buckle housing 101 may be shaped in the form of a popular culture figure such as a children's cartoon character or other popular icon. In certain embodiments the belt buckle housing 101 may include an area for adhering or otherwise attaching a popular culture figure such as a children's cartoon character or other popular icon. In one embodiment the display area 162 may double as an area for adhering or otherwise attaching the popular culture figure. One of skill in the art will recognize that in certain embodiments the popular culture figure may be integrally molded with the belt buckle housing 101.

In one embodiment, the belt buckle housing 101 includes a watertight seal between the front cover 102 and the back cover 104 such that the belt buckle housing is waterproof and substantially airtight. In such an embodiment, the speakers 106a and 106b may include marine grade speakers such that the speakers 106a and 106b may be used in an aquatic environment.

In one embodiment, the speakers 106a and 106b face away from the user. The speakers 106a and 106b may be situated on any surface of the belt buckle housing 101 that does not face the user. In certain embodiments the speakers 106a and 106b may be movable within the belt buckle housing 101 such that the speakers 106a and 106b can be aimed in a desired direction. In such an embodiment, a pivotable mount for attaching each speaker 106a and 106b may be included within the belt buckle housing 101.

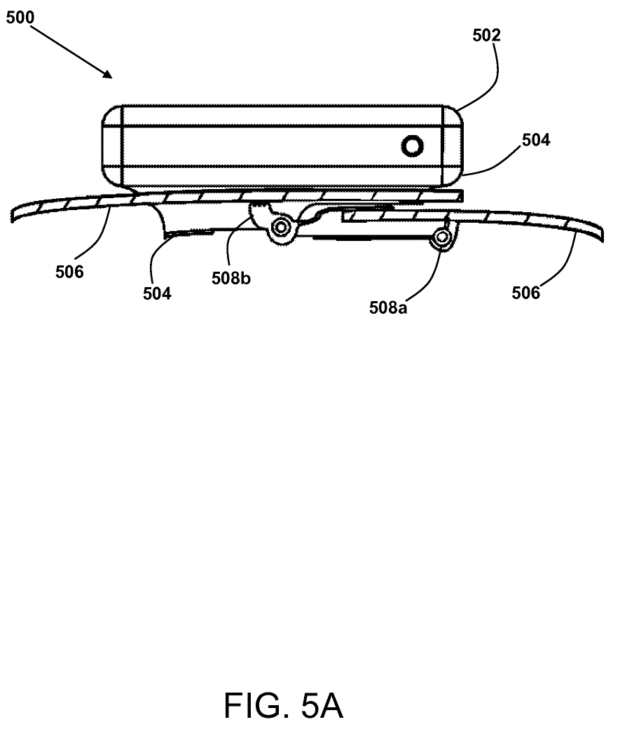

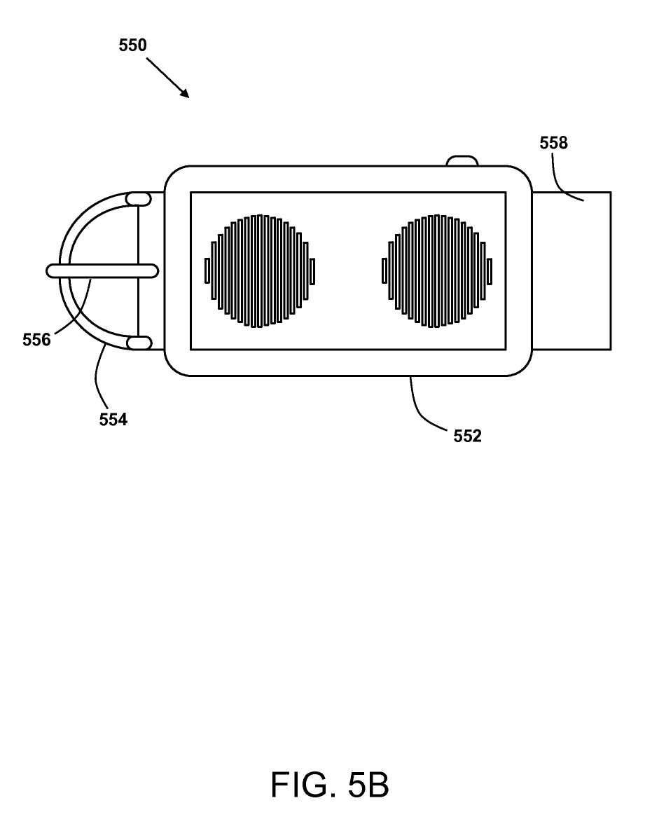

In one embodiment, the front cover 102 of the audio belt buckle 100 contains two speaker grills 110a and 110b which contain holes to allow the sound to pass through the front cover 102. In another embodiment, the speaker grills 110a and 110b contain parallel cut-out lines which allow the sound to pass through the front cover 102, as shown in FIG. 5B. One of skill in the art will recognize other methods of allowing sound to pass through the front cover 102 including, for example, placing fabric material over the speakers, placing a single large hole over each speaker and placing thin plastic material over each speaker. In certain embodiments, the belt buckle housing 101 may include holes for receiving the speakers 106a and 106b with nothing covering the speakers 106a and 106b. In such an embodiment speaker grills 110a and 110b may be omitted.

In one embodiment, a top 103 of the audio belt buckle 100 includes an audio input receiver 108 that accepts a standard 3.5 mm male plug common to most commercial portable audio players. In another embodiment, the audio input receiver 108 may be replaced with a length of wire connected or directly hardwired to the audio belt buckle 100. The length of wire may contain a 3.5 mm male plug used to plug into an audio player or other source. In this embodiment, the audio source and the audio belt buckle 100 can be separated by a distance substantially similar to the length of the length of wire while still retaining a hardwired connection. In other embodiments, the 3.5 mm male plug may be replaced by a type of USB connector or USB receiver, larger 0.25 inch connector, 3 pin connector, RCA plug, or any other audio connector.

In certain embodiments, the front and back covers 102, 104 can be made from other materials, such as aluminum, precious metals, wood, and the like, or through another method, such as die casting, machining, carving, and the like. One skilled in the art also recognizes that the belt buckle housing 101 can be formed from parts of different shapes, from more than two main parts, or from a single part. The audio belt buckle 100 may also attach to the belt in different methods known in the art.

In certain embodiments, the audio belt buckle 100 apparatus contains an audio input receiver 108 to receive sound from an analog audio source. In the embodiment shown in FIG. 1A, the audio input receiver is on top 103 of the audio belt buckle 100, held in place by a rounded notch in the front cover and a semi-circular protrusion in the back cover of the audio belt buckle 100. One skilled in the art recognizes that the audio input receiver can be located anywhere on the audio belt buckle 100, and that a hole can be drilled into the belt buckle housing 101 rather than injection-molded into the covers 102, 104. In another embodiment, audio input is received through a pair of standard RCA jacks through the belt buckle housing 101. In that embodiment, two holes are formed, either by drilling, molding, forming at the seam, or some other means. In a further embodiment, the audio belt buckle 100 contains a male audio plug which can plug directly into an audio source without an additional cable. In another embodiment, the male audio plug may be attached to the end of a cable which connects the audio device to the audio belt buckle 100.

In one embodiment, the audio belt buckle 100 can be used to play music from many different sources, such as portable digital music players, cellular phones, PDAs, compact disc players, cassette players, AM/FM radio receivers, MP3 players, satellite radio receivers, computers, home stereo systems, and the like. In another embodiment, the audio belt buckle 100 can play audio from a system capable of delivering a mono or stereo audio signal through a cable.

FIG. 1B depicts one embodiment of a backside view of the wearable speaker. In this embodiment, the back cover 104 is substantially rectangular and contains rounded edges. In one embodiment, a loop 150 may attach to a loop end of a user's belt (not shown). The belt may snap or otherwise attaches to itself, locking the audio belt buckle 100 to the belt by way of the loop 150. In another embodiment, a pin 152 may also hook in an appropriate hole on the other end of the user's belt, while the excess length of belt is fed through loop 150. The pin 152 may be constructed of the same material as the back cover 104 or it may be constructed of a different material and affixed to the back cover 104. The pin 152 protrudes from the back cover 104 and may be angled toward the loop 150 to better secure the user's belt.

In another embodiment, the audio belt buckle 100 may attach to a belt buckle of a user's belt through a magnetic connection. In another embodiment, the audio belt buckle 100 may be permanently attached to a user's belt or belt buckle through the use of an adhesive. One of skill in the art will recognize other methods of connecting the audio belt buckle 100 to a commercially available belt.

In one embodiment, the audio belt buckle 100 contains a power source such as a battery (not shown) coupled with an amplification device (not shown). In the embodiment of FIG. 1B, the power source is a typical AA battery. In other embodiments, the power source may be any type of disposable, rechargeable battery, or any other type of power source. A battery cover 154 may be placed on the back cover 104 of the audio belt buckle 100 to hold the battery in place. In one embodiment, the battery cover 154 on the back cover 104 of the audio belt buckle 100 is removable without tools through the use of a lever 155. In one embodiment, a screw 158 holds the front cover 102 and back cover 104 of the audio belt buckle 100 securely together. In certain embodiments the battery cover 104 may be omitted and back cover 104 may hold the power source within the belt buckle housing 101.

The power source can be held in place by a spring or springs to ensure constant contact between the electrical leads and the battery. One skilled in the art recognizes that different types of batteries can be used to supply power to the device, such as a AAA battery, a button-type watch battery, a rechargeable Li-Ion battery, an array of multiple batteries, or the like. Further, one skilled in the art will recognize that other methods of securing the battery can be used, such as solder, snap-in plugs, and the like. In one embodiment, the amplification device contains connection wires protruding from the device in a fixed position. The connection wires may insert directly into a battery holder in the front cover. In certain embodiments the battery holder is integrally molded into the front cover such that the battery holder and front cover are a single unitary part. When the connection wires insert into the battery holder and a battery is placed in the holder, electrical contact is made without further soldering or other connection steps. One skilled in the art will recognize the trade-offs that accompany battery selection, including factors such as cost, commercial availability, size, battery life, ease of replacement, and the like.

One skilled in the art recognizes that if a rechargeable battery is chosen for a particular embodiment, a plug for a power supply to recharge the battery can be attached in the same fashion as the audio input receiver 108 in the embodiment shown in FIG. 1A. In one embodiment, the apparatus is powered by an external battery which may be placed in the user's pocket or attached to the user's belt, or by a power adapter that plugs into a wall or vehicle outlet. In certain embodiments, especially those in which the battery is intended to be replaced infrequently or never, the battery cover 154 is attached with a screw. In another embodiment, there is no separate battery cover but rather the back cover of the audio belt buckle 100 covers the battery as well as the other internal components.

In one embodiment, the battery contact leads are connected by wires soldered onto a board. In another embodiment, the battery lead wires plug into a socket attached to a board. One skilled in the art recognizes that the electrical power connection can be made in multiple ways and that the method chosen can be based on factors such as manufacturing convenience, durability, cost, and the like. Such substitutions are considered within the scope of the present invention disclosed herein.

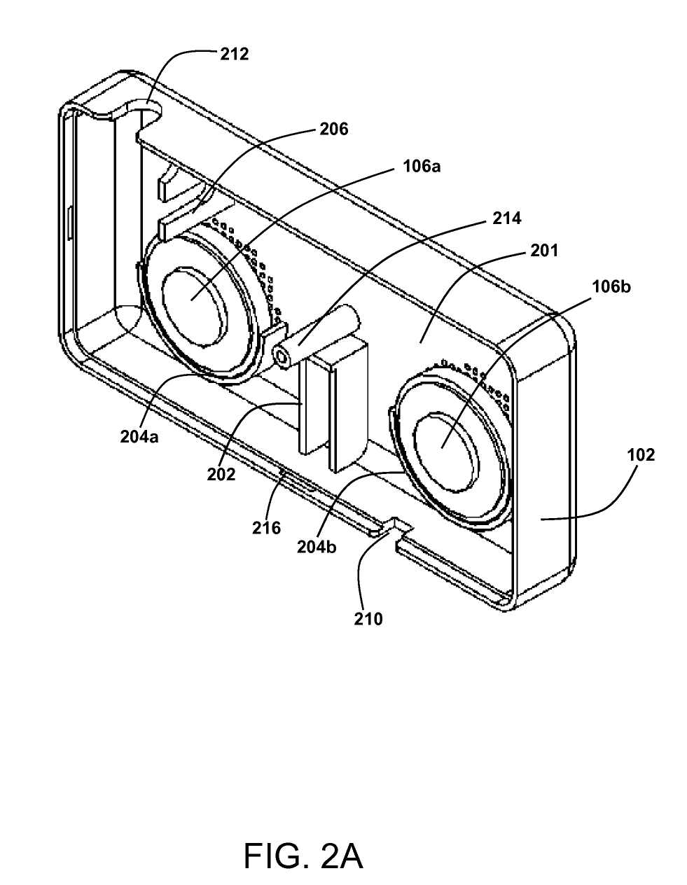

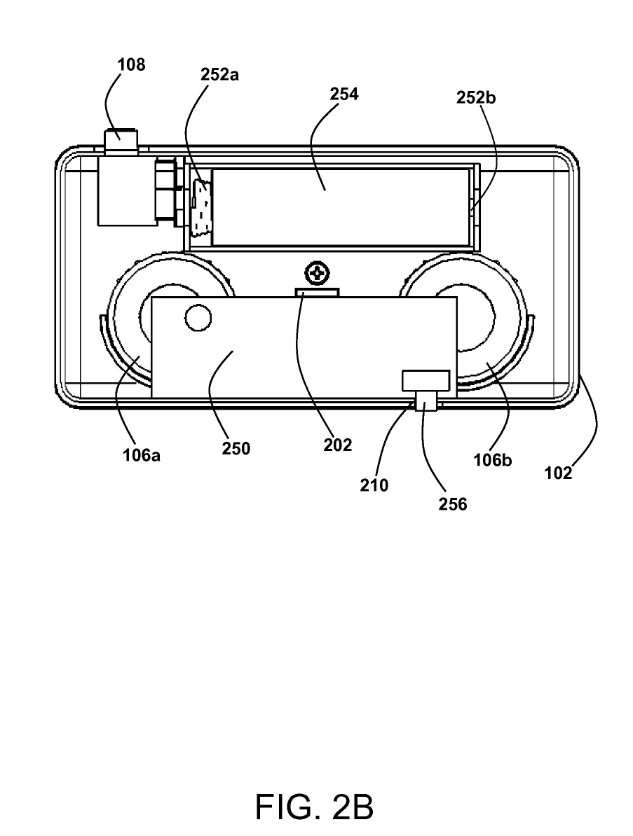

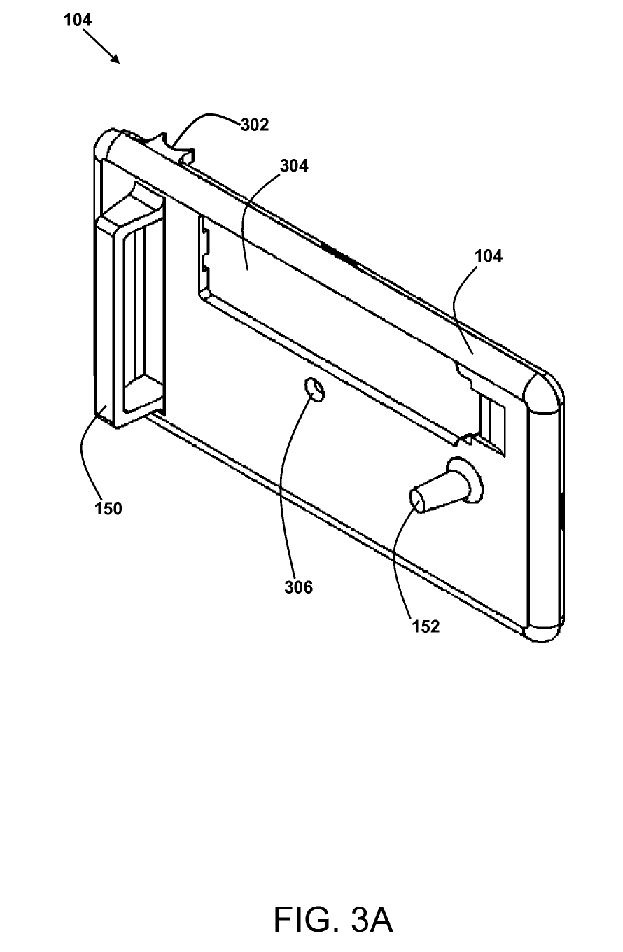

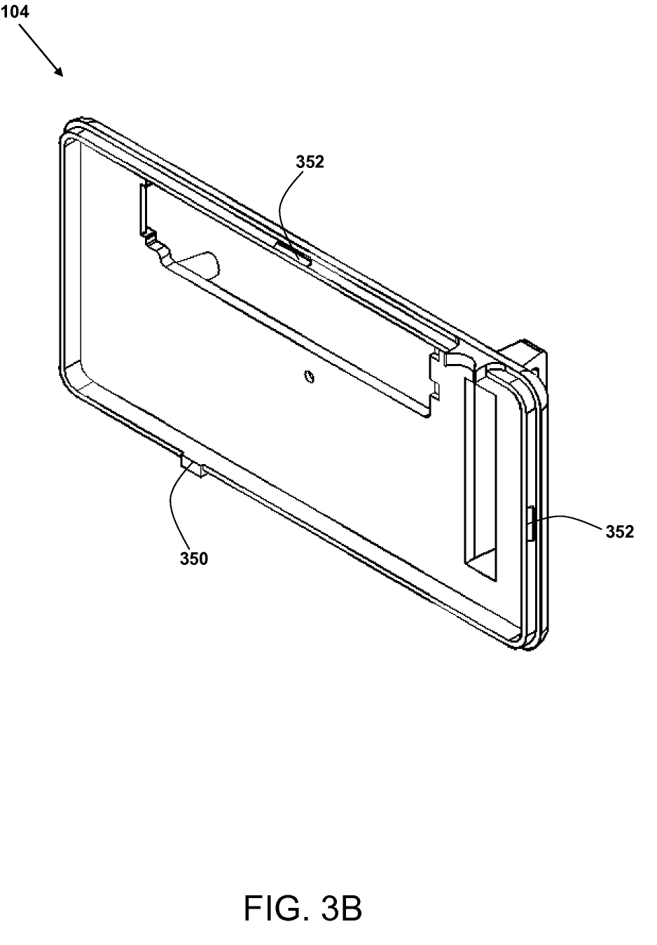

One skilled in the art will recognize that the amplification device, battery, and speakers can be attached to the audio belt buckle 100 covers 102, 104 and each other by various methods, such as but not limited to screws, glue, friction fit, solder, springs, and the like. In addition, the tabs 352 and grooves 216 shown in FIGS. 3B and 2A can be replaced with tabs and grooves of various size and configuration. In other embodiments, the tabs and grooves are omitted and a screw or multiple screws can hold the audio belt buckle 100 together.

One skilled in the art recognizes that some components can be omitted or rearranged without deviating from the disclosed invention. In one embodiment, the power supply is omitted and the speakers derive their power from the audio source.

FIG. 1C depicts a side view of one embodiment of an audio belt buckle 100 showing the front cover 102 attached to the back cover 104. The loop 150 has an open area 154 disposed between the loop 150 and the back cover 104 such that a user's belt may slide through the open area 154. The loop 150 may be sized to accommodate different sizes and styles of belts. The pin 152 protrudes away from the back cover 104 to engage a hole in the belt.

FIG. 2A depicts one embodiment of a view the cavity 201 inside the front cover 102. In one embodiment, the front cover 102 comprises an amplifier bracket 202 which may hold an amplifier device in place, two semi-circular brackets 204a and 204b which may hold speakers 106a, 106b, and a slot 206 which may hold a battery (not shown). In one embodiment, the speakers 106a and 106b may rest in the semi-circular brackets 202a and 202b. In certain embodiments a thin piece of low-density foam (not shown) cut to the diameter of the speakers may be disposed between the speakers 106a and 106b and the front cover 102 to prevent vibration of the speakers 106a and 106b within the front cover 102 and to protect the speakers while in use.

In one embodiment, the front cover 102 has a rectangular notch 210 at the bottom edge of the cover which is designed to receive an on/off switch. In another embodiment, the front cover 102 also has a notch 212 with rounded corners for the audio input receiver 108. In certain embodiments the belt buckle housing may include user interface controls, such as an audio input control that controls the audio input such as the file played or the music source, an audio output that controls audio output such as volume, and a power control that turns the audio belt buckle 100 on or off. One of skill in the art will recognize that these user interface controls may be located anywhere on the belt buckle housing 101. One of skill in the art will recognize that in certain embodiments additional user interface controls may be included within the belt buckle housing 101 depending on the capabilities of the audio source. In one embodiment the user interface controls may be omitted and the volume, song selection and power may be controlled by the audio source.

In one embodiment, a screw hole 214 is molded into the front cover 102 and configured to receive a screw 158. In one embodiment, slots 216 may be molded in the sides of the front cover 102 to allow the back cover 104 to snap into place such that the sides of back cover 104 are retained in the slots 216.

FIG. 2B depicts another embodiment of an inside of the front cover 102. In certain embodiments the speakers 106a and 106b are further held in place by an amplification device 250. In one embodiment the amplification device 250 is a commercially available amplification card that boosts an audio signal. The amplification device 250 may comprise connections (not shown) to the battery leads 252a and 252b, which connect to the battery 254. The battery 254 may thus provide power to the amplification device 250. In one embodiment, the amplification device 250 also comprises a power switch 256, which protrudes from a notch 210 on the bottom of the front cover 102. The amplification device 250 may also comprise connections (not shown) to the leads on the audio input receiver 108. In one embodiment, the amplification device 250 is held in place by the power switch 256 and the bracket 202 molded into the front cover 102 of the audio belt buckle 100. In another embodiment, the amplification device 250 is also glued in place to prevent it from moving during use.

FIG. 3A depicts a back view of a back cover 104 of one embodiment of the audio belt buckle 100. In one embodiment, the back cover 104 comprises a protrusion 302 on the top edge to hold the audio input receiver 108 in place. The protrusion fits inside notch 212 and, when the two covers 102 and 104 are snapped together, the notch 212 and protrusion 302 form a round hole for the audio input receiver 108. In certain embodiments, the back cover contains an opening 304 for the battery cover 154 and a hole 306 for the screw 158.

FIG. 3B depicts an inside view of the back cover 104 of one embodiment of the audio belt buckle 100. The back cover 104 may contain a brace 350 configured to hold the power switch 256 in place. The back cover 104 may also contain tabs 352 on one or more side of the back cover 104. The tabs 352 snap into the slots 258 on the front cover 102.

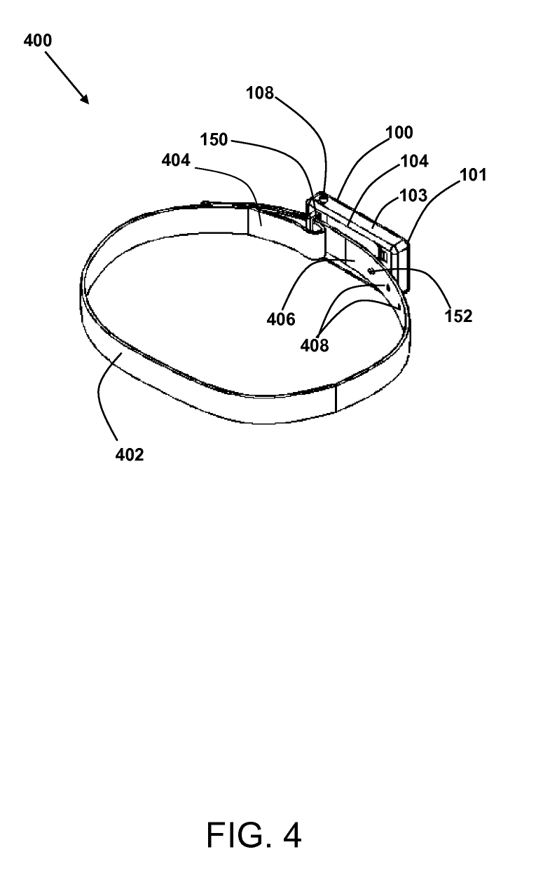

FIG. 4 depicts one embodiment of a system 400 containing an audio belt buckle 100 and a belt 402. The system 400 contains an audio belt buckle 100 which may contain features shown in the embodiments of FIGS. 1A, 1B, 1C, 2A, 2B, 3A and 3B and discussed above. In one embodiment, these features include a belt buckle housing 101, at least one speaker 106a and 106b, an audio receiver 108, an amplification device 250 and a power source such as a battery 254. The belt buckle housing 101 may contain a front cover 102, a back cover 104, and a center cavity 201. The belt buckle housing 101 may be coupled to a first end 404 of the belt and configured to secure an opposing end 406 of the belt to hold the belt around the waist of the user. As shown in FIG. 4, the belt buckle housing 101 may contain a pin 152 configured to fit within a hole 408 on the opposing end 406 of the belt 402. As shown in FIG. 4, the back cover 104 faces the user and the at least one speaker 106a, 106b (not shown) are directed away from the user.

In one embodiment, an audio input receiver 108 is located on the top 103 of the belt buckle housing 101. The audio input receiver 108 may be located on any portion of the belt buckle housing 101. The amplification device 250 and power source such as battery 254 are located within cavity 201 the belt buckle housing 101.

One skilled in the art recognizes that the audio input receiver 108 can be replaced or supplemented by a wireless receiver. In one embodiment, the audio belt buckle 100 can receive wireless signals from devices such as Bluetooth capable phones, audio devices and computers. In addition to the previously described application of listening to recorded audio content, a user can use this embodiment as a portable hands-free speakerphone. In this embodiment, one or more additional user interface controls can be added on the audio belt buckle 100 to allow for proper use and communication with only trusted devices.

In use, the belt 402 is connected to the audio belt buckle 100 at the first end 404 by the loop 150, as shown in FIG. 4. The belt 402 passes around a user's waist and is connected at the other end by the pin 152. An audio source can then be connected to the audio input receiver 108. The belt 402 is removed from the user by removing the pin 152 from the hole 408 in the belt 402.

FIGS. 5A and 5B depict two additional embodiments of the audio belt buckle 500. FIG. 5A shows a top view of one embodiment of the audio belt buckle 500. In this embodiment, the belt 506 is a friction-type belt and the front cover 502 of the audio belt buckle 100 is configured similar to the front cover 102 of the embodiment shown in FIG. 1A. The back cover 504 of the audio belt buckle 100 apparatus 500 is configured to couple with a belt 506 using friction clasps 508a and 508b. The belt buckle housing contains friction clasps 508a and 508b configured to removably attach to the belt 506. One of skill in the art will recognize other configurations of friction clasps 508a, 508b which can be used to hold the belt of a user.

FIG. 5B shows another embodiment in which the belt is a typical loop-bar style belt. The audio belt buckle 550 comprises a front cover 552 substantially similar to the front cover 102 in FIG. 1A. The back cover 104 (not shown) contains a loop 554 and bar 556. The loop 554 and bar 556 hold a belt 558 together around a user.

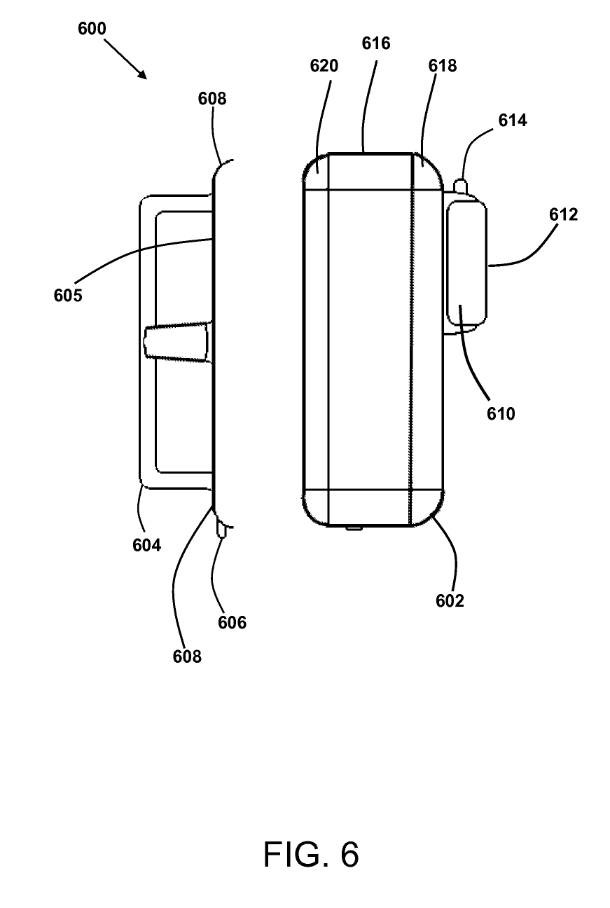

FIG. 6 shows another embodiment in which the audio belt buckle 600 contains a speaker assembly 602 that is detachable from a bracket 608. In certain embodiments, a button 606 is configured to release the speaker assembly 602 from the bracket 608 or set of brackets when pressure is applied to the button 606. In such an embodiment the belt buckle housing 616 includes the front cover 618, the back cover 620 and a center cavity (not shown) which combined make up the speaker assembly 602. The bracket 608 may remain connected with the belt of a user while the speaker assembly 602 is removed. Thus, the speaker assembly 602 may be disengaged from the bracket 608 for use elsewhere, to recharge a battery, or to upload audio files onto an audio source, such as a portable music player 612 coupled with the speaker assembly 602. In one embodiment, the speaker assembly 602 is configured to stand upright on a surface when removed from the bracket 608. When the speaker assembly is released, a structural back plate 605 provides support for the bracket 608. The audio belt buckle 600 may attach to the belt in the same manner as in embodiments shown in Figures B, 5A, 5B, or by some other method known in the art.

In certain embodiments, the speaker assembly 602 may comprise an audio source receiving port 610 that is sized hold a portable music player 612. The music player 612 may be released from the audio source receiving port 610 by the press of a button 614. The music player 612 can be connected to an audio input receiver (not shown) by a cable (not shown). The music player 612 may also connect to an audio input receiver that is located within the audio source receiving port 610. For example, in one embodiment, a connection between the music player 612 and the audio input receiver 616 is made when the music player 612 is inserted in the audio source receiving port 610.

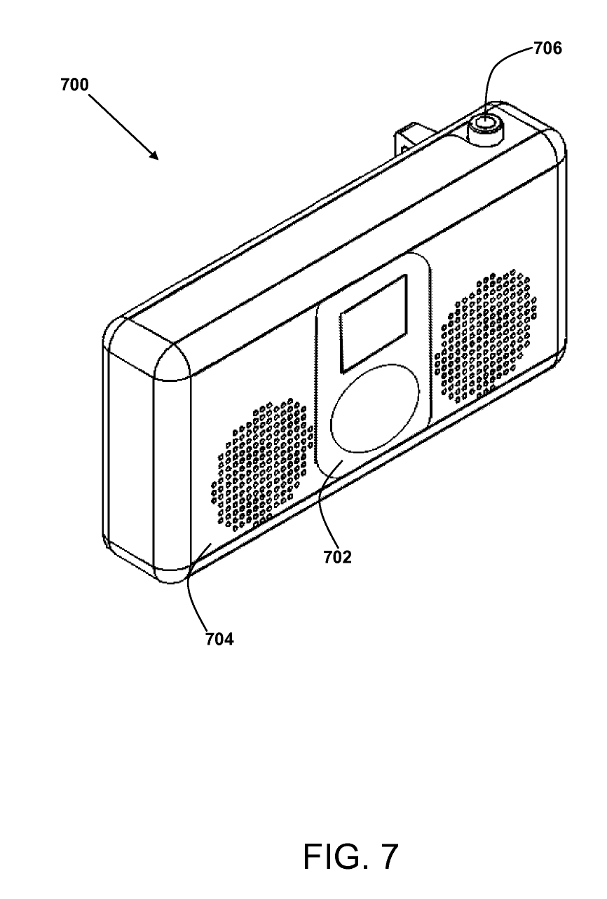

FIG. 7 illustrates another embodiment of an audio belt buckle 700 in which the audio belt buckle 700 is configured to house an audio device 702. The audio device 702 may be configured to nest with the speaker assembly 704 such that the speaker assembly 704 supports the audio device 702. The speaker assembly 704 and audio device 702 may connect to one another using a data and battery connections on the audio device 702 such that an external connection to the audio input receiver 706 may be unnecessary in certain embodiments.

In one embodiment, the input audio may be controlled through the use of input controls on the audio device 702. In another embodiment, the input audio may be controlled through a user interface (not shown) on the belt buckle housing.

In one embodiment, the audio belt buckle 100 includes one or more microphones as the audio source. In another embodiment, the audio belt buckle 100 can be configured to transmit the audio by a wireless or wired connection. In yet another embodiment, the audio belt buckle 100 includes an integral digital storage device such that audio files can be stored on the digital storage device.

In one embodiment, the audio belt buckle 100 contains a built-in digital music player and/or an AM/FM radio receiver. Similarly, in one embodiment the audio belt buckle 100 contains a digital video player configured to play videos or display pictures. In another embodiment, the audio belt buckle 100 contains a music decoder that generates an audio signal, a digital storage device, and a user interface to control what audio input and output. One skilled in the art recognizes that user interface controls and digital input and output ports such as buttons, knobs, and USB ports can be added to allow the user to import, play, and export digital audio files. In one embodiment, the audio belt buckle 100 comprises a docking station to make file transfer to and from a computer more convenient.

One skilled in the art recognizes that the audio belt buckle 100 can be adapted to be a pendant, necklace, bracelet, arm band, or the like by exchanging the back cover with appropriate connection mechanisms. In one embodiment, the audio belt buckle 100 can be configured with a clip to attach to a user's belt or pants in a plurality of positions. The audio belt buckle 100 may be decorated with any combination of paint, decals, etchings, photographs, beads, jewels, or the like. In one embodiment, the belt buckle housing 101 of the audio belt buckle 100 is configured to stand upright when detached from the user's belt.

One skilled in the art recognizes that the components of the apparatus can be rearranged within the apparatus to accommodate manufacturing constraints, customer demand, or other factors without deviating from the claimed invention. The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An audio belt buckle comprising:
a belt buckle housing coupled to a first end of a belt of a user, the belt buckle housing configured to secure an opposing end of the belt to hold the belt around the waist of a user;
at least one speaker coupled to the belt buckle housing and directed away from the user's body; and
an audio input receiver coupled to the belt buckle housing wherein the audio input receiver is configured to receive audio input from an audio source and wherein the audio input receiver is coupled to the at least one speaker.

2. The audio belt buckle of claim 1, wherein the belt buckle housing comprises a substantially planar front surface, the substantially planar front surface comprising a display area for communicating a message.

3. The audio belt buckle of claim 1, wherein the belt buckle housing is shaped as a popular culture figure.

4. The audio belt buckle of claim 3, wherein the popular culture figure comprises a cartoon character.

5. The audio belt buckle of claim 1, wherein the audio input receiver comprises a wireless input receiver.

6. The audio belt buckle of claim 1, wherein the audio input receiver comprises an audio socket configured to receive an audio plug, the audio socket electrically coupled to the at least one speaker, the audio plug comprising a length of wire coupled to an output audio jack at a proximal end and an input audio jack at the distal end, wherein the output audio jack is configured to interface with the audio socket and the input audio jack is configured to interface with the audio source.

7. The audio belt buckle of claim 1, further comprising a microphone and a microphone power source, the microphone comprising an acoustic to electric sensor that converts a sound into an electrical signal, the microphone coupled to the audio input receiver such that the audio input receiver receives the electrical signal as the audio input.

8. The audio belt buckle of claim 1, wherein the belt buckle housing comprises a front cover, a back cover, and a center cavity, wherein the at least one speaker is disposed on the front cover of the belt buckle housing and is directed away from the center cavity.

9. The audio belt buckle of claim 1, wherein the belt buckle housing comprises a loop and a pin disposed on an outer surface of the belt buckle housing, wherein the loop is configured to couple to the first end of the belt and the pin is configured to fit within a hole on the opposing end of the belt.

10. The audio belt buckle of claim 1, further comprising:
an audio source disposed within the belt buckle housing;
a music decoder coupled to the audio source and configured to decode an audio signal from the audio source, the music decoder disposed within the belt buckle housing; and
a user interface disposed within the belt buckle housing, the user interface comprising an audio input control configured to control audio input and an audio output control configured to control audio output.

11. The audio belt buckle of claim 1, wherein the audio source is disposed within the belt buckle housing and wherein the audio source comprises an audio storage device configured to store electronic audio files.

12. The audio belt buckle of claim 1, wherein the belt buckle housing further comprises an audio source receiving port, the audio source receiving port configured to removably receive the audio source.

13. The audio belt buckle of claim 1, further comprising a bracket, wherein the belt buckle housing comprises a speaker assembly wherein the bracket is configured to attach to the user's belt to secure the first end of the user's belt to the opposing end of the belt and wherein the speaker assembly is removably attached to the bracket.

14. A system for securing an audio belt buckle to a user, the system comprising:
a belt worn on a user's waist;
a belt buckle housing comprising a speaker assembly having a front cover, a back cover and a center cavity
a bracket coupled to a first end of the belt and configured to secure an opposing end of the belt to hold the belt around the waist of the user, wherein the speaker assembly is removably attached to the bracket.
at least one speaker coupled to the front cover of the belt buckle housing and directed away from the user's body;
an audio input receiver coupled to the belt buckle housing wherein the audio input receiver is configured to receive audio input from an audio source and wherein the audio input receiver is coupled to the at least one speaker;
an amplification device coupled to the audio input receiver and the at least one speaker; and
a power source coupled with the amplification device.

15. The system for securing an audio belt buckle to a user of claim 14, wherein the belt buckle housing is shaped as a popular culture figure.

16. The system for securing an audio belt buckle to a user of claim 14, wherein the audio input receiver comprises a wireless input receiver.

17. The system for securing an audio belt buckle to a user of claim 14, further comprising:
an audio source disposed within the belt buckle housing;
a music decoder coupled to the audio source and configured to decode an audio signal from the audio source, the music decoder disposed within the belt buckle housing; and
a user interface disposed within the belt buckle housing, the user interface comprising an audio input control configured to control audio input and an audio output control configured to control audio output.

18. The system for securing an audio belt buckle to a user of claim 14, wherein the belt buckle housing further comprises an audio source receiving port, the audio source receiving port configured to removably receive the audio source.

19. An audio belt buckle comprising:
a belt buckle housing comprising a front cover, a back cover, a center cavity, and an audio source receiving port, the belt buckle housing coupled to a first end of a belt and configured to secure an opposing end of the belt to hold the belt around a user's waist, the audio source receiving port configured to removably receive an audio source;
at least one speaker coupled with the belt buckle housing and directed away from the user's body;
an audio input receiver coupled with the belt buckle housing wherein the audio input receiver is configured to receive audio input from the audio source and wherein the audio input receiver is coupled to the at least one speaker;
an amplification device coupled to the audio input receiver and the at least one speaker; and
a power source coupled with the amplification device.

20. The audio belt buckle of claim 19, further comprising a bracket, wherein the belt buckle housing comprises a speaker assembly wherein the bracket is configured to connect to the user's belt to secure the first end of the user's belt to the opposing end of the belt and wherein the speaker assembly is removably attached to the bracket.
